(19) United States
(12) Patent Application Publication
(10) Pub. No.: US 2026/0298175 A1
(43) Pub. Date: Oct. 1, 2026

(54) Boxer Engine and Vehicle with a Boxer Engine

(71) Applicant: Dr. Ing. h.c. F. Porsche Aktiengesellschaft, Stuttgart (DE)

(72) Inventor: Werner Verdoorn, Ludwigsburg (DE)

(73) Assignee: Dr. Ing. h.c. F. Porsche Aktiengesellschaft, Stuttgart (DE)

(21) Appl. No.: 19/634,559

(22) Filed: Mar. 31, 2026

(30) Foreign Application Priority Data
Apr. 1, 2025 (DE) 10 2025 112 711.5

(51) Int. Cl. F02F 7/00; F01P 3/08; F02B 75/24; F01P 3/00

(52) U.S. Cl. CPC F02F 7/0009; F01P 3/08; F02B 75/243; F02F 7/0021; F01P 2003/006; F02F 2007/0041

(57) ABSTRACT

The boxer engine includes two opposite cylinder banks. A crankshaft with a crankshaft axis (A) is arranged between the cylinder banks. The crankcase is composed of a first housing part and a second housing part and is configured to support the crankshaft. At least one fastener is provided to connect the two housing parts by at least one fastener hole provided for receiving the fastener on the first housing part and at least one fastener hole provided for receiving the fastener on the second housing part. The fastener holes, and thus the fastener, are arranged, such that at least one end of the fastener projects into a cylinder. At this end, a nozzle connected to a cooling oil supply is arranged, which is configured and arranged to spray a crown of a piston arranged in the cylinder with cooling oil provided by the cooling oil supply.

### CROSS-REFERENCE TO RELATED APPLICATION

This application claims priority to German Patent Application No. 10 2025 112 711.5, filed Apr. 1, 2025, which is incorporated by reference herein in its entirety.

### FIELD OF THE INVENTION

The present invention relates to a boxer engine and a vehicle with a boxer engine.

### BACKGROUND OF THE INVENTION

In boxer engines, a crankcase made of two parts is screwed together. The crankcase serves as the bearing for the crankshaft. There is the challenge of implementing a screw connection that is optimally positioned with respect to the screw connection of the bearing bridge in order to be able to absorb as much force as possible.

DE 10 040 476 C1, which is incorporated by reference herein in its entirety, discloses a boxer engine having oppositely situated cylinders and a crankcase, wherein the crankcase is composed of two crankcase parts screwed together, wherein the separation plane between the crankcase parts is arranged in the area of the crankshaft. The crankcase parts are screwed together, such that the screws are inserted through, and screwed into, the cylinders. DE 60 124 847 T2, which is incorporated by reference herein in its entirety, also describes a screw connection of two crankcase halves of a boxer engine, wherein the crankcase parts are screwed together, such that the screws are inserted through, and screwed into, the cylinders. A boxer engine having oppositely situated cylinders and a crankcase is known from DE 4 001 514 A1, which is incorporated by reference herein in its entirety, wherein the crankcase is composed of two crankcase parts screwed together.

### SUMMARY OF THE INVENTION

It would be desirable to provide a boxer engine that combines an advantageous connection of the two crankcase parts with advantageous cooling of the boxer engine, as well as to provide a vehicle having such a boxer engine.

The boxer engine according to aspects of the invention comprises two opposite cylinder banks comprising at least one cylinder. A crankshaft with a crankshaft axis is arranged between the cylinder banks. The crankcase is composed of a first housing part and a second housing part and is configured to support the crankshaft. At least one fastener (e.g., screw, bolt, etc.) is provided to connect the two housing parts by at least one screw hole provided for receiving the screw on the first housing part and at least one screw hole provided for receiving the screw on the second housing part. The screw holes have a thread, in particular. The screw holes, and thus the screw, are arranged such that at least one end of the screw projects into a cylinder. The screw is thus mounted, in particular, via or through the cylinder. At this end, a nozzle connected to a cooling oil supply is arranged, which is configured and arranged to spray a crown of a piston arranged in the cylinder with cooling oil provided by the cooling oil supply. In the context of the application, cooling oil refers to any type of cooling fluid that would be possible for such use.

Several advantages over the prior art can be achieved by the boxer engine according to aspects of the invention. Firstly, the arrangement of the nozzle at one end of the screw projecting into the cylinder allows efficient cooling of the piston. This contributes to improved heat dissipation and prevents overheating of the piston during operation. Secondly, selectively spraying the piston crown with cooling oil provides uniform cooling and reduces thermal stresses in the piston material. Thirdly, integrating the cooling oil nozzle into the screw simplifies the boxer engine design and reduces the number of required components, reducing manufacturing costs and facilitating maintenance. In addition, by arranging the screw such that the nozzle protrudes into the cylinder to spray the piston with cooling oil, an arrangement can be provided, in which the screw connection is made close to the crankshaft axis and is thus well suited for absorbing the forces of the crankshaft. Overall, the boxer engine according to aspects of the invention results in improved performance and reliability of the engine with an improved, weight-saving screw connection of the two crankcase parts.

In an advantageous embodiment of the invention, the cylinder banks are arranged offset from one another with respect to the crankshaft axis, such that central axes of individual cylinders of a first cylinder bank and central axes of individual cylinders of a second cylinder bank do not point to the crankshaft axis. This arrangement allows for a more compact design of the engine, as the offset cylinder banks utilize the available space more efficiently. In addition, this arrangement can achieve better cooling and ventilation of the cylinders, resulting in improved thermal efficiency and a longer service life of the engine components. By means of the offset arrangement, the force flow of the screw can be positioned even closer to the crankshaft axis.

In an advantageous embodiment of the invention, an oil channel inlet of the screw, configured to be fed by a cooling oil supply and to be in fluid contact with the nozzle via an oil channel, is arranged outside of the crankcase. The oil channel inlet (53) thus provides an interface, through which cooling oil enters the crankcase. This arrangement allows for easier and faster engine maintenance, as access to the cooling oil supply and the corresponding connections is facilitated. Moreover, positioning the oil channel inlet outside the crankcase improves the cooling performance of the system, as the cooling oil can be supplied and distributed more efficiently. This helps reduce operating temperatures and increase the service life and performance of the engine.

In an advantageous embodiment of the invention, an oil channel inlet in communication with a cooling oil supply is arranged at the end of the screw opposite the nozzle, and an oil channel for fluidly connecting the oil channel inlet to the nozzle is arranged inside the screw. This arrangement allows for targeted and efficient cooling of the piston, as the cooling oil is directed directly through the screw to the nozzle. This increases the cooling performance, resulting in better temperature control and a longer service life of the pistons and the entire engine. In addition, this design simplifies the integration of the cooling oil system, as no additional external lines are required, reducing the complexity and weight of the engine.

In an advantageous embodiment of the invention, the separation plane of the two housing parts passes through the crankshaft axis. This arrangement allows for more precise and stable support of the crankshaft, as the two housing parts are arranged symmetrically about the crankshaft axis. Moreover, this design simplifies the assembly and disassembly of the crankcase, as the crankshaft is directly accessible when the housing parts are separated. This significantly facilitates maintenance and repairs. By symmetrically partitioning the housing, the forces acting on the crankshaft may also be more evenly distributed, resulting in increased crankshaft life and overall improved engine operating efficiency.

In an advantageous embodiment of the invention, the screw holes are arranged, such that the screw is arranged in parallel to a central axis of the cylinder. This arrangement allows for optimal power transfer and increases the structural integrity of the engine, as the loads are evenly distributed along the length of the screw. In addition, the parallel alignment of the screws facilitates assembly and disassembly of the engine, as the screws are more easily accessible and fewer transverse forces act on the screw connections. This contributes to higher engine stability and reliability and reduces the risk of mechanical failures. The improved alignment of the screws may also increase the accuracy of the cooling oil supply to the nozzle, further improving the efficiency of piston cooling.

In an advantageous embodiment of the invention, at least two screws are arranged per cylinder. This arrangement improves the stability and strength of the connection between the housing parts, as the load is distributed over a plurality of screws. As a result, the mechanical stress is reduced on each individual screw, resulting in increased longevity and reliability of the connections. In addition, by using multiple screws, better sealing of the crankcase is achieved, minimizing the risk of leakage. The improved distribution of forces also helps to reduce vibrations and noise, making the operation of the engine smoother and more efficient. Overall, this configuration allows for a more robust and resilient engine design.

In an advantageous embodiment of the invention, the nozzle is arranged in a screw head of the screw. This arrangement allows a precise and direct supply of the cooling oil to the piston, as the nozzle is in close proximity to the area to be cooled. This optimizes cooling efficiency and ensures even distribution of the cooling oil. The integration of the nozzle into the screw head also simplifies the design and reduces the number of components needed, making it easier to assemble and maintain the engine. The compact design also saves space and weight, resulting in an overall more efficient and lighter engine design. This configuration thus contributes to improving the thermal efficiency and operational reliability of the engine.

In an advantageous embodiment of the invention, the screw is arranged, such that the nozzle is angled relative to the central axis of the cylinder. This means that the nozzle is oriented so that the cooling oil is sprayed as centrally as possible onto the crown of the piston. The screw may be aligned in parallel to the central axis of the piston, wherein the nozzle has a different spray direction than the longitudinal direction of the screw, or may be angled relative to the central axis. This arrangement allows targeted and controlled spraying of the piston crown with cooling oil, since the spray angle can be optimally adjusted to the areas to be cooled. The angled orientation of the nozzle allows the cooling oil to be distributed more efficiently and heat to be better dissipated, improving the cooling performance and thermal stability of the engine. In addition, the precise orientation of the nozzle can help to minimize oil consumption, as the cooling oil is used exactly where it is needed most. This leads to overall more efficient cooling and prolongs the life of the pistons and the entire engine.

In an advantageous embodiment of the invention, the nozzle is configured to be adjustable such that a spray direction and/or a quantity of the supplied cooling oil is adjustable. This arrangement allows for flexible and precise control of piston cooling, as the nozzle can be individually adjusted to the specific cooling requirements. The adjustability of the spray direction allows the cooling oil to be directed toward the most stressed areas of the piston, resulting in more efficient heat dissipation and more even temperature distribution. In addition, the ability to regulate the quantity of cooling oil allows for optimum use of the cooling medium, which reduces oil consumption and lowers operating costs. This flexible cooling regulation significantly contributes to increasing engine life and reliability, as it prevents piston overheating and minimizes thermal stress on engine components.

The motor vehicle according to aspects of the invention comprises a boxer engine according to aspects of the invention.

### BRIEF DESCRIPTION OF THE DRAWINGS

Advantageous aspects of the invention are explained in more detail below with reference to the accompanying figures. The figures show:

FIG. 1 shows a schematic view of a cross-section of an embodiment of a boxer engine 1 according to aspects of the invention along a crankshaft axis A.

FIG. 2 shows a schematic view of the embodiment of the boxer engine 1 of FIG. 1 in a cross-section transverse to the crankshaft axis A.

### DETAILED DESCRIPTION OF THE INVENTION

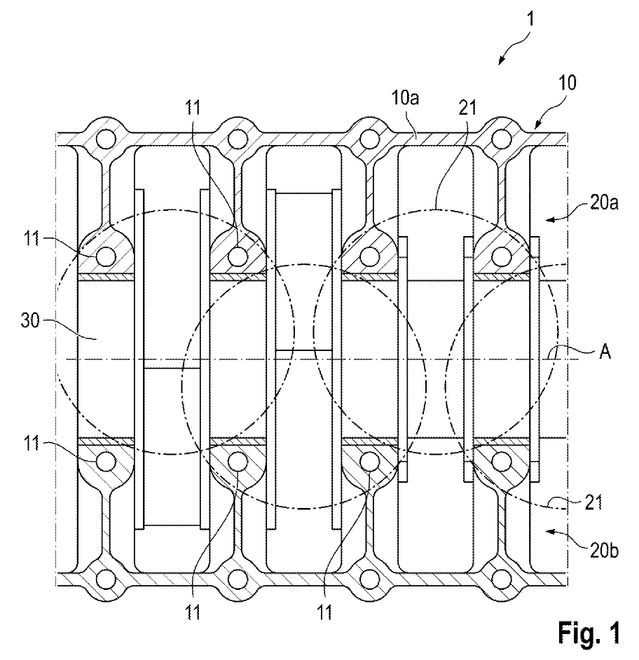

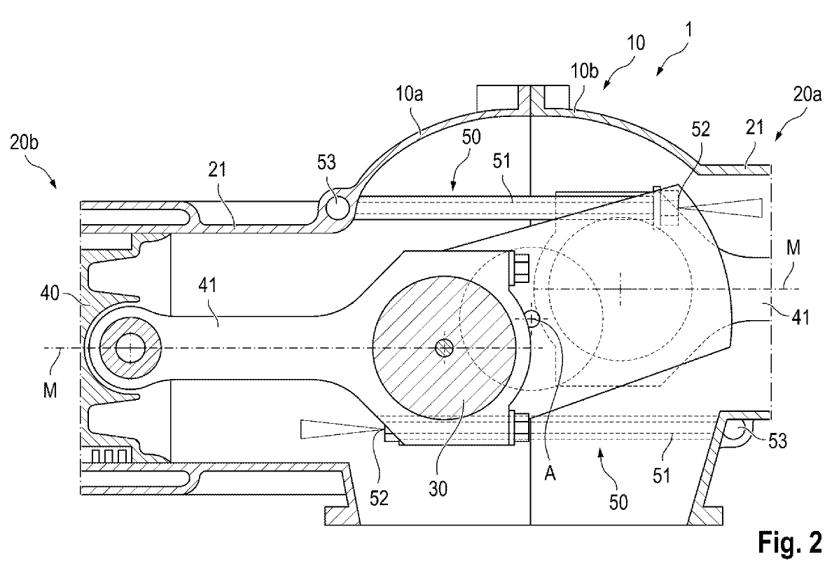

FIGS. 1 and 2 show an embodiment of a boxer engine 1 according to the invention. FIG. 1 shows an excerpt of a cross-section along a crankshaft axis A, while FIG. 2 shows an excerpt of a cross-section transverse to the crankshaft axis A.

The boxer engine 1 comprises a crankshaft 30 supported in a crankcase 10. The crankcase 10 is formed in two parts and is composed of a first housing part 10a and a second housing part 10b. The housing parts 10a, 10b are connected by screw connections, which are located on the exterior of the crankcase 10 and extend transversely to the crankshaft axis A.

The boxer engine 1 further comprises two cylinder banks 20a, 20b that are arranged offset from one another, such that the central axes M of individual cylinders 21 of the first cylinder bank 20a and the central axes M of individual cylinders 21 of the second cylinder bank 20b do not point to the crankshaft axis A. The cylinders are thus offset in a vertical z direction, or height direction, assuming the boxer engine 1 is installed in a position such that the cylinders 21 extend horizontally.

Pistons 40 arranged in the cylinders 21 move along the central axes M of the cylinders 21 and drive the crankshaft 30 about the crankshaft axis A via a connecting rod 41.

The housing parts 10a, 10b of the crankcase 10 further comprise screw holes 11, which are arranged at the bearing locations of the crankshaft 30 in the crankcase 10. Screws 50 are inserted through the screw holes 11, which screws connect the two housing parts 10a, 10b together. For this purpose, the screw holes 11 preferably comprise threaded sections.

Due to the offset arrangement of the cylinders 21 in the vertical z direction, the screws 50 are arranged, such that they extend into a cylinder and thus also must be inserted into the screw holes 11 through the cylinders 21 during assembly of the crankcase 10. At the same time, the opposite ends of the screws 50 extend out of the crankcase 10 and may be secured outside the crankcase 10, for example by a nut.

The close arrangement of the screw connections, by the screws 50 at the crankshaft axis A, can ensure good introduction of force, so that a weight-optimized and strength-optimized arrangement can be provided. Furthermore, the screws 50 are arranged in parallel to the crankshaft axis A and the central axes M of the cylinders 21, such that a homogeneous force acting in the longitudinal direction of the screws 50 can be ensured and transverse stresses on the screws 50 can be largely prevented. As a result, the screws 50 can be made smaller and lighter.

Furthermore, each of the ends of the screws 50 projecting into a cylinder 21 comprises a nozzle 52. This is connected to an oil channel inlet via an oil channel 51 formed in the screw 50. A cooling fluid, in particular cooling oil, is supplied there by a cooling oil supply. By way of the nozzles 52, the cooling oil can be sprayed directly into the cylinders 21, more specifically onto the crown of the pistons 40, thus improving cooling of the pistons and/or reducing the quantity of cooling oil needed. This can increase the efficiency.

The nozzle 52 on the screws 50 can be positioned or aligned, such that the cooling oil optimally reaches the areas to be cooled in the cylinder 21. In particular, the nozzle 52 is configured to be adjustable so that the flow rate and/or direction of the cooling oil discharge can be adjusted. This can also be understood to mean that the quantity of cooling oil provided at nozzle 52 is adjustable.

### LIST OF REFERENCE SIGNS

1 Boxer engine

10 Crankcase

10a First housing part

10b Second housing part

11 Screw hole

20a First cylinder bank

20b Second cylinder bank

21 Cylinder

30 Crankshaft

40 Piston

41 Connecting rod

50 Screw

51 Oil channel

52 Nozzle

53 Oil channel inlet

A Crankshaft axis

M Central axis

1. A boxer engine comprising:
two opposite cylinder banks,
a crankshaft arranged between the cylinder banks, the crankshaft having a crankshaft axis (A),
a crankcase which is configured to support the crankshaft, the crankcase comprising a first housing part and a second housing part,
at least one fastener connecting the two housing parts,
at least one fastener hole on the first housing part that receives the fastener, at least one fastener hole on the second housing part that receives the fastener, wherein the fastener holes and the fastener are arranged such that at least one end of the fastener projects into a cylinder of the crankcase, and
a nozzle connected to a cooling oil supply, wherein the nozzle is arranged at said at least one end of the fastener, the nozzle being configured and arranged to spray a crown of a piston arranged in the cylinder with cooling oil provided by the cooling oil supply.

2. The boxer engine according to claim 1, wherein the cylinder banks are arranged offset relative to one another with respect to the crankshaft axis (A) such that central axes (M) of individual cylinders of a first cylinder bank and central axes (M) of individual cylinders of a second cylinder bank do not point to the crankshaft axis (A).

3. The boxer engine according to claim 1, wherein an oil channel inlet of the fastener, which is fed by the cooling oil supply and in fluid contact with the nozzle via an oil channel, is arranged at least partially outside of an interior space of the crankcase.

4. The boxer engine according to claim 1, wherein an oil channel inlet in communication with the cooling oil supply is arranged at the end of the fastener that is opposite the nozzle, and an oil channel for fluidly connecting the oil channel inlet to the nozzle is arranged inside the fastener.

5. The boxer engine according to claim 1, wherein a separation plane of the first and second housing parts runs through the crankshaft axis (A).

6. The boxer engine according to claim 1, wherein the fastener holes are arranged, such that the fastener is arranged in parallel to a central axis (M) of the cylinder.

7. The boxer engine according to claim 1, wherein at least two of the fasteners are arranged per cylinder.

8. The boxer engine according to claim 1, wherein the nozzle is arranged in a fastener head of the fastener.

9. The boxer engine according to claim 1, wherein the fastener is arranged such that the nozzle is angled relative to a central axis (M) of the cylinder.

10. The boxer engine according to claim 1, wherein the nozzle is adjustable such that a spray direction and/or a quantity of the supplied cooling oil is adjustable.

11. The boxer engine according to claim 1, wherein an oil channel inlet of the fastener, which is fed by the cooling oil supply and in fluid contact with the nozzle via an oil channel, is arranged at least partially outside of an interior space of the crankcase, wherein the oil channel inlet is in communication with the cooling oil supply and is arranged at the end of the fastener that is opposite the nozzle, and the oil channel for fluidly connecting the oil channel inlet to the nozzle is arranged inside the fastener.

12. A motor vehicle comprising the boxer engine according to claim 1.
